(19) United States
(12) Patent Application Publication
(10) Pub. No.: US 2026/0280712 A1
(43) Pub. Date: Sep. 17, 2026

(54) DISTRIBUTED RETRODIRECTIVE ARRAY OF MOBILE TETHERED ELEMENTS

(71) Applicant: Raytheon Company, Arlington, VA (US)

(72) Inventors: David D. Crouch, Farragut, TN (US); James J. Richardson, Temecula, CA (US)

(21) Appl. No.: 19/080,632

(22) Filed: Mar. 14, 2025

(51) Int. Cl. H04B 10/2575; H04L 5/00

(52) U.S. Cl. CPC H04B 10/25759; H04L 5/0048

(57) ABSTRACT

A system includes an input configured to receive a plurality of detected scattered signals from a target. The system also includes a common ground station configured to receive the detected scattered signals, determine phase conjugations of the detected scattered signals, and generate phase-conjugated signals. The system further includes an output configured to provide the phase-conjugated signals from the common ground station to each of a plurality of array elements of a distributed retrodirective array. The phase conjugations of the detected demodulated scattered signals enable the phase-conjugated signals to arrive at the target having substantially a same phase.

### TECHNICAL FIELD

This disclosure relates generally to distributed arrays. More specifically, this disclosure relates to a distributed retrodirective array of mobile tethered elements.

### BACKGROUND

A variety of applications involving the disruption of targets (such as drones, vehicles, etc.) involve irradiating a target with a moderate-to-high radio frequency (RF) power density signal. The RF power density signal can disrupt the operations of electronics in the target, causing the target to be disabled. Examples of such signals include RF directed energy, radar, and electronic warfare signals. Currently, these types of missions are carried out by large aircraft (both manned and unmanned), large ground vehicles, and large ground-based structures operating from a standoff distance. These types of large systems often protect high-value targets from an adversary. The sizes of these systems are often driven to a large degree by the radiated power and prime power requirements needed to overcome losses associated with transmitting RF signals through free space (typically referred to as 1/R² losses).

### SUMMARY

This disclosure relates to a distributed retrodirective array of mobile tethered elements.

In some examples, a system includes an input configured to collect a plurality of RF modulated optical signals scattered from a target. The system also includes a common ground station configured to receive and demodulate the collected plurality of RF modulated optical signals scattered from the target and to phase conjugate the received collected plurality of demodulated RF modulated optical signals scattered from the target to generate phase-conjugated RF signals. The system also includes an output configured to provide the phase-conjugated RF signals from the common ground station to each of a plurality of array elements of a distributed retrodirective array. The system also includes phase conjugation of the received plurality of demodulated RF modulated optical signals scattered from the target that enables the phase-conjugated RF signals to arrive at the target having substantially a same phase.

Any single one or any combination of the following features may be used with the examples above. The system where element-dependent phase of the phase-conjugated RF signals transmitted from the common ground station to the target is cancelled by equal and opposite phase accumulated during propagation from the ground station to the target. The system may include the plurality of array elements forming the distributed retrodirective array, the array elements configured to detect scattered signals from a virtual beacon on the target and to transmit the phase-conjugated RF signals to the target and a plurality of tethered connections configured to connect the array elements to the common ground station and transport the collected plurality of RF modulated optical signals scattered from the target and the phase-conjugated demodulated RF signals between the array elements and the common ground station. A transmission distance between the target and the common ground station through each of the array elements is different for at least some of the array elements. The array elements form a three-dimensional distributed retrodirective array. The scattered signals from the virtual beacon contain a radio frequency (RF) pilot signal. The common ground station may include central phasing circuitry configured to generate the phase-conjugated RF signals in response to the collected plurality of RF modulated optical signals scattered from the target. The central phasing circuitry may include a master oscillator configured to generate a master oscillation signal, a plurality of phase conjugation circuits, each phase conjugation circuit associated with one of the array elements and configured to generate the phase-conjugated RF signals responsive to the master oscillator signal and a received RF pilot signal and an optical transmitter configured to transmit a virtual beacon signal that creates an RF-modulated virtual beacon on the target in response to the master oscillation signal.

In other examples, a method includes receiving a plurality of RF modulated optical signals scattered from a target from a plurality of array elements of a distributed retrodirective array at a common ground station over a plurality of tethered connections. The method also includes demodulating the plurality of RF modulated optical signals scattered from the target at the common ground station. The method also includes phase conjugating the received collected plurality of demodulated RF modulated optical signals scattered from the target to generate phase conjugated RF signals at the common ground station. The method also includes transmitting phase-conjugated RF signals from the common ground station to the array elements over the tethered connections.

Any single one or any combination of the following features may be used with the examples above. The method where transmitting an element-dependent phase of the phase-conjugated RF signals from the common ground station to the target cancels an equal and opposite phase accumulated during propagation from the ground station to the target. The phase-conjugated RF signals arrive at the target having substantially a same phase. The scattered signals from the virtual beacon are modulated by a radio frequency (RF) pilot signal. The method may include forming a three-dimensional distributed retrodirective array with the array elements. A transmission distance between the target and the common ground station through each of the array elements is different for at least some of the array elements. Phase conjugation may include generating the phase-conjugated RF signals in response to the received plurality of RF modulated optical signals scattered from the target using central phasing circuitry. The central phasing circuitry may include a master oscillator configured to generate a master oscillation signal, a plurality of phase conjugation circuits, each phase conjugation circuit associated with one of the array elements and configured to generate the phase-conjugated RF signals responsive to the master oscillator signal and a received RF pilot signal and an optical transmitter configured to transmit a virtual beacon signal that creates an RF-modulated virtual beacon on the target in response to the master oscillation signal.

In still other examples, a distributed retrodirective array system includes a plurality of array elements configured to form a three-dimensional distributed retrodirective array, the array elements configured to collect a plurality of scattered RF-modulated optical signals from a virtual beacon modulated by a radio frequency (RF) pilot signal on a target and transmit phase-conjugated signals to the target. The system also includes a common ground station configured to receive and demodulate the collected plurality of scattered RF modulated optical signals from the target and to phase conjugate the received collected plurality of demodulated scattered RF modulated optical signals to generate phase-conjugated RF signals. The system also includes a plurality of tethered connections configured to connect the array elements to the common ground station and transport the collected plurality of scattered RF-modulated optical signals and the phase-conjugated RF signals between the array elements and the common ground station. The system also includes where conjugated phases of the collected plurality of demodulated scattered RF-modulated optical signals enable the phase-conjugated RF signals to arrive at the target having substantially a same phase.

Any single one or any combination of the following features may be used with the examples above. The system where the phase-conjugated RF signals add coherently at the target in response to the substantially same phase of the phase-conjugated RF signals. A transmission distance between the target and the common ground station through each of the array elements is different for at least some of the array elements. The common ground station further may include central phasing circuitry may include a master oscillator configured to generate a master oscillation signal, a plurality of phase conjugation circuits, each phase conjugation circuit associated with one of the array elements and configured to generate the phase-conjugated RF signals responsive to the master oscillator signal and a received RF pilot signal and an optical transmitter configured to transmit a virtual beacon signal that creates an RF-modulated virtual beacon on the target in response to the master oscillation signal.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example use of a distributed retrodirective array for irradiating a target according to this disclosure;

FIG. 2 illustrates example signal transmissions associated with irradiating a target from an array element of a distributed retrodirective array connected to a common ground station according to this disclosure;

FIG. 3 illustrates an example array element and an example common ground station according to this disclosure;

FIG. 4 illustrates an example phase conjugation process performed by a common ground station according to this disclosure;

FIG. 5 illustrates example array elements connected to a common ground station over varied tether lengths according to this disclosure; and

FIG. 6 illustrates an example process for irradiating a target with a distributed retrodirective array according to this disclosure.

### DETAILED DESCRIPTION

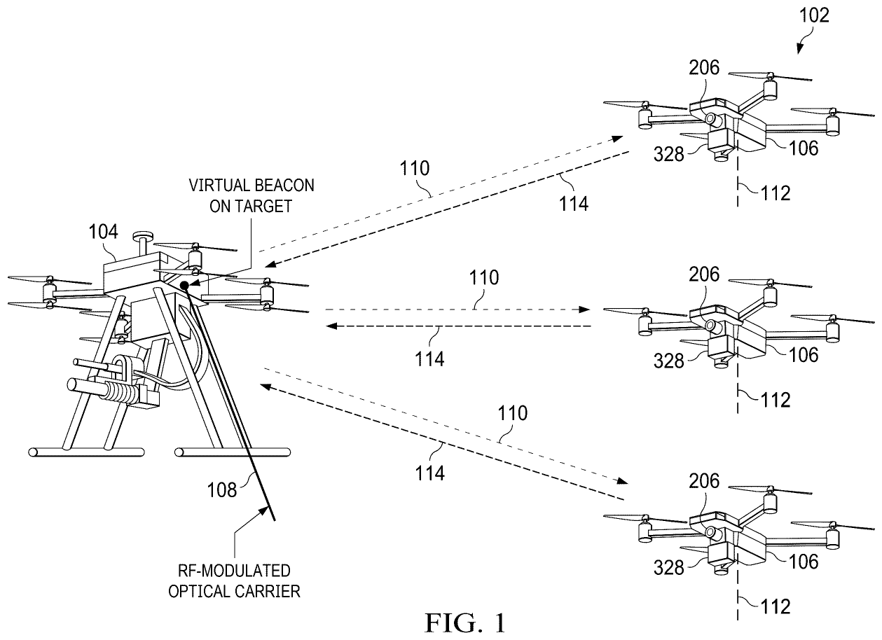

FIGS. 1 through 6, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

A variety of applications involving the disruption of targets (such as drones, vehicles, etc.) involve irradiating a target with a radio frequency (RF) signal having moderate-to-high power density. The RF signal can disrupt the operations of electronics in the target, causing the target to be disabled. Examples of such signals include RF directed energy, radar, and electronic warfare signals. Currently, these types of missions are carried out by large aircraft (both manned and unmanned), large ground vehicles, and large ground-based structures operating from a standoff distance. These types of large systems often protect high-value targets from an adversary. The sizes of these systems are often driven to a large degree by the radiated power and prime power requirements needed to overcome losses associated with transmitting RF signals through free-space (typically referred to as 1/R² losses). This disclosure provides distributed retrodirective arrays of tethered elements that can irradiate targets while being mobile.

FIG. 1 illustrates an example use of a distributed retrodirective array 102 for irradiating a target 104 according to this disclosure. As shown in FIG. 1, the distributed retrodirective array 102 includes a number of array elements 106. The distributed retrodirective array 102 can automatically retransmit RF signals back towards a virtual beacon without prior knowledge of the incoming signals. The distributed retrodirective array 102 includes a network of individual mutually-coherent airborne array elements 106 spread across a wider area, where each array element 106 can independently receive a signal and retransmit the signal back towards the source. This creates a “retrodirective” beam that automatically points back to the origin of the signal without any need for complex calculations or prior knowledge of the signal's direction. The distributed retrodirective array 102 can therefore provide a distributed system that collectively acts like a single retrodirective antenna array, where each array element 106 contributes to the overall beamforming process. In some embodiments, the array elements 106 include a plurality of drones. Also, the array elements 106 may be distributed in three-dimensional space in any suitable manner, such as uniformly or randomly. In addition, the array elements 106 may be in motion, and the array elements 106 can be independent from each other so that, if one array element 106 is disabled or destroyed, the distributed retrodirective array 102 can still continue to function.

In order to achieve coherence from the distributed retrodirective array 102 between the signals transmitted from various array elements 106 to the target 104, a collimated RF-modulated optical carrier 108 can be projected from a source laser to illuminate a spot on the target 104 to form a virtual beacon. The virtual beacon can scatter from the target 104, and the scattered light 110 can be distributed over a wide solid angle from the target 104 and may be collected by each of the array elements 106. As will be more fully described below, the RF pilot signal included within the scattered light 110 arriving at each of the array elements 106 can be collected and transmitted to a common ground station (not shown) over tethers 112 connected between the array elements 106 and the ground station. In some embodiments, each tether 112 may include a single-mode fiber.

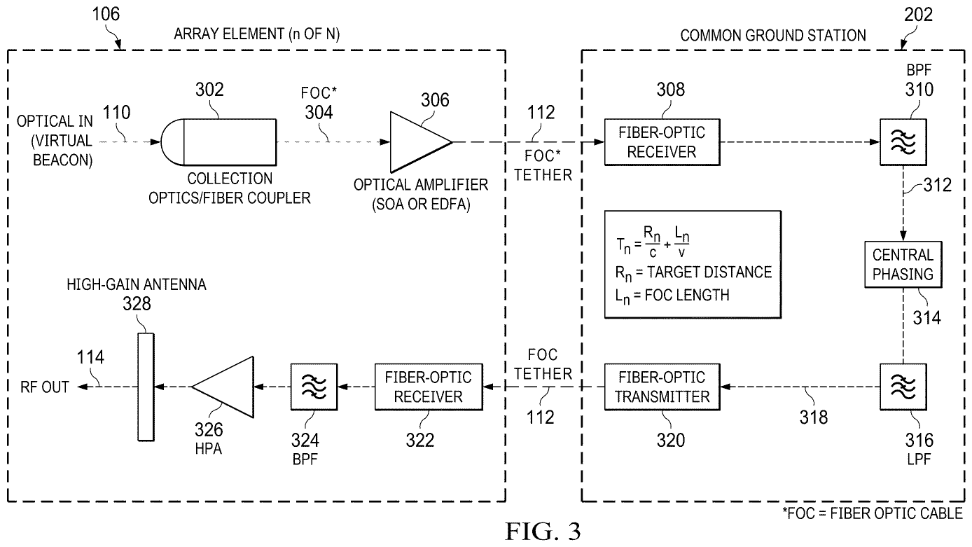

Phase conjugation may be performed on the received RF signals as will be more fully described below. As more particularly illustrated in FIG. 3, the signals transmitted between each array element and the ground station are not RF signals but are RF modulated optical signals. Phase-conjugated RF signals are received from the ground station as RF modulated optical signals via the tethers 112, and phase-conjugated RF signals 114 are transmitted back to the target 104. Since the signal phases for the phase-conjugated RF signals 114 arriving at the target 104 from the array elements 106 are substantially identical, peak power can be closer to N² times that from a single element, where N is the number of elements in the distributed retrodirective array 102.

Note that the array elements 106 of the distributed retrodirective array 102 need not be physically or electromagnetically connected with each other directly. Rather, the array elements 106 may only have the tethers 112 to the common ground station. Also, the array elements 106 may not require precision station keeping. The array elements 106 need not be tied to a fixed regular grid and may move about relative to other array elements within three-dimensional space. Thus, the distributed retrodirective array 102 may not need the array elements 106 to be located on a regular planar grid or to remain in fixed positions. Furthermore, the array elements 106 may not need to maintain their positions with respect to a fixed reference point or with respect to other array elements.

Although FIG. 1 illustrates one example use of a distributed retrodirective array 102 for irradiating a target 104, various changes may be made to structure illustrated in FIG. 1.

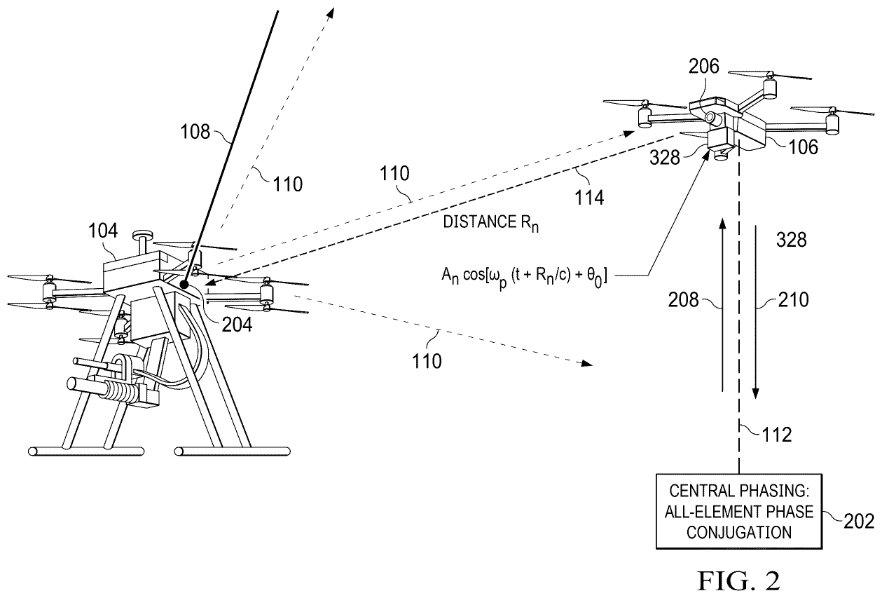

FIG. 2 illustrates example signal transmissions associated with irradiating a target 104 from an array element 106 of a distributed retrodirective array 102 connected to a common ground station 202 according to this disclosure. The collimated RF-modulated optical carrier 108 here is projected from a laser onto the target 104. In some embodiments, the scattered virtual beacon signal arriving at the ground station from n^{th} array element may be represented by the following equation.

$$S ( t ) = [ a + b cos ( {ω}_{p} t + {θ}_{0} ) ] cos ( {ω}_{c} t )$$

where:
ωₚ=2πfₚ=RF pilot signal frequency
ω_{c}=2πf_{c}=Carrier frequency
θ₀=Arbitrary modulation phase
aₙ and bₙ are signal amplitudes
t is time
Tₙ represents a time delay accounting for propagation from the target to the n^{th} array element

$${T}_{n} = \frac{{R}_{n}}{c} + \frac{{L}_{n}}{v}$$

where:
Rₙ=Distance from the target to the n^{th} array element
Lₙ=Path length from n^{th} array element to ground station
c=The speed of light in free space
v=The speed of light along path between the n^{th} array element and the ground station

The collimated RF-modulated optical carrier 108 creates a virtual beacon 204 on a surface of the target 104. The virtual beacon 204 reflects from the target 104 as scattered light 110. The scattered light 110 is captured by collection optics 206 associated with the array element 106. In some embodiments, the array element 106 may include an onboard optical amplifier and RF transmitter. Collection optics on board each array element 106 capture scattered light and impress it onto an optical fiber of the tether 112 for transmission to the common ground station 202. Within the common ground station 202 an optical receiver converts the optical signal to an electrical signal containing multiple frequency components, one of which is the RF pilot signal. In an alternative embodiment, the optical receiver is on the array element 106. An RF-modulated optical signal may be transmitted from the optical receiver over a fiber optic cable of the tether 112.

The common ground station 202 can perform phase conjugation on the received RF pilot as will be more fully described below and transmit a phase-conjugated RF pilot 208 back to the array element 106 over the tether 112. The array element 106 can transmit a phase-conjugated RF signal 114 from the antenna 328 back to the target 104. The phase-conjugated RF signal 114 transmitted by the n^{th} element has a phase wₚRₙ/c. On the return trip from the n^{th} element to the target, the signal accumulates a phase −wₚRₙ/c due to propagation over the distance Rₙ. At the target, the two phases cancel, yielding a signal of the form Aₙ cos[ωₚt−θ₀] In this manner, the phases of signals received at the target 104 from the array elements 106 are substantially identical. As mentioned previously, this causes a peak power closer to N² times that due to a single element at the target 104, where N is the number of elements 106 in the distributed retrodirective array 102. The radiated signals 114 transmitted from the array elements 106 to the target 104 may therefore add coherently at the target 104.

In some embodiments, central phasing performed by the common ground station 202 may occur in the following manner. The virtual beacon 204 is an RF-modulated high-frequency carrier (such as an infrared, visible, or near-ultraviolet laser beam) that illuminates a small spot on the target 104 (such as a spot with a diameter less than the wavelength of the RF modulation). The illuminated spot can serve as both a target designator, communicating to the elements of the array 102 where to point their antennas 206, and as a mechanism for distributing frequency and phase information. The frequency of the RF modulation facilitates frequency synchronization among the elements of the array 102. The phase accumulated in target-to-element propagation has its sign reversed via phase conjugation and is cancelled in propagating back to the target following transmission. As a result, the signals transmitted by the elements arrive at the target 104 with the same or substantially the same phase. That is, all signals can arrive at the target with a substantially common phase, yielding (ideally) an amplitude N times that of a single element.

In some embodiments, an amplitude of the virtual beacon signal may have the following form.

$$S ( t ) = [ a + b cos ( {ω}_{p} t + {θ}_{0} ) ] cos ( {ω}_{c} t )$$

The virtual beacon signal can be diffusely scattered from the target 104 over a wide solid angle. Optics onboard each array element 106 can collect the scattered light. In some embodiments, the light can be coupled into the end of a single-mode fiber-optic cable, amplified, and transmitted to a ground-based or other optical receiver. The optical receiver can convert the amplified light into an electrical signal prior to phase conjugation.

Although FIG. 2 illustrates one example of signal transmissions associated with irradiating a target 104 from an array element 106 of a distributed retrodirective array 102 connected to a common ground station 202, various changes may be made to structure illustrated in FIG. 2.

FIG. 3 illustrates an example array element 106 and an example common ground station 202 according to this disclosure. As shown in FIG. 3, within the array element 106, the scattered light 110 from the virtual beacon 204 can be received at collection optics/fiber coupler 302 of the array element 106. For example, collection optics 302A can receive the scattered light 110 that is scattered from the target 104, and a fiber coupler 302B can couple the received signal onto a fiber-optic cable (FOC) 304. The received signal can be amplified at an optical amplifier 306. In some cases, the optical amplifier 306 may include a semiconductor optical amplifier (SOA) or an erbium doped fiber amplifier (EDFA). The amplified signal can be transmitted over the tether 112, which may include an optical fiber, to the common ground station 202. A fiber-optic receiver 308 within the ground station 202 extracts an RF pilot signal and converts the optical signal into an electrical signal.

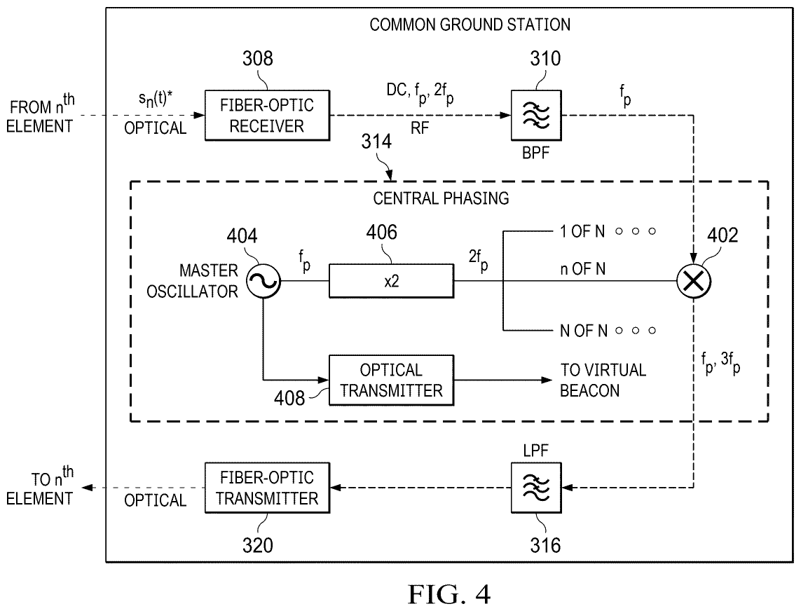

The common ground station 202 can receive the amplified optical signal from the array element 106 at a fiber-optic receiver 308. The received signal may be processed by a bandpass filter 310 to remove signals except for the desired RF pilot signal 312 contained within the signal received from the array element 106. In some cases, the desired RF pilot signal 312 may be expressed as Aₙ cos[wₚ(t−Tₙ)+θ₀]. The extracted pilot signal 312 can be provided to central phasing circuitry 314 that phase conjugates the signal as more fully described below with respect to FIG. 4.

The phase-conjugated signal can be output from the central phasing circuitry 314 and processed by a low-pass filter 316 in order to provide a phase-conjugated signal 318 that is transmitted back to the array element 106. In some cases, the phase-conjugated signal 318 may be expressed as Bₙ cos[ωₚ(t+Tₙ)−θ₀]. The phase conjugation performed by the central phasing circuitry 314 reverses a sign of accumulated propagation delay in the signal received from the array element 106. For example, the accumulated propagation phase may include the phase provided by the optical fiber. By reversing the sign of the accumulated propagation phase, the phase is cancelled on the return trip from the common ground station 202 to the array element 106 such that the signals from all array elements 106 can arrive at the target 104 with the same or substantially the same common phase. The fiber-optic transmitter 320 uses the phase-conjugated signal 318 to modulate an optical carrier. The resulting RF modulated optical signal generated by the fiber-optic transmitter 320 is transmitted to the array element 106 over the tether 112, which may include a fiber-optic cable.

The phase-conjugated signal 318 can be received at a fiber-optic receiver 322 of the array element 106. The received phase-conjugated RF signal can be processed at a bandpass filter 324 and amplified by a high-power amplifier (HPA) 326. The amplified phase-conjugated signal can be transmitted from a high gain antenna 328 of the array element 106 to the target 104. In some cases, the amplified phase-conjugated signal at the target may be expressed as Dₙ cos[ωₚt−θ₀].

Although FIG. 3 illustrates one example of an array element 106 and one example of a common ground station 202 according to this disclosure, various changes may be made to structure illustrated in FIG. 3.

FIG. 4 illustrates an example phase conjugation process performed by a common ground station 202 according to this disclosure. More specifically, FIG. 4 illustrates an example implementation of the central phasing circuitry 314 of FIG. 3 and signal processing associated therewith. As shown in FIG. 4, the received scattered signal sₙ(t) is received by the fiber-optic receiver 308. The fiber-optic receiver 308 outputs various signals at DC and frequencies fₚ and 2fₚ responsive to the scattered signal. The bandpass filter 310 provides the RF input signal Aₙ cos[ωₚ(t−Tₙ)+θ₀] into the central phasing circuitry 314.

Within the central phasing circuitry 314, a mixer circuit 402 mixes a signal provided from a master oscillator 404. The master oscillator 404 generates the signal used for frequency synchronization, not the received RF signal. The master oscillator 404 provides an oscillation signal having a frequency fₚ that is multiplied (such as by a factor of two) using a multiplier circuit 406 and provided to the mixer circuit 402. Note that there can be a separate mixer circuit 402 associated with each of the signals received from the array elements 106. The multiplied oscillator signals from the multiplier circuit 406 can be provided to each of the mixer circuits 402 associated with the array elements 106. Additionally, the master oscillator 404 provides the oscillation signal to an optical transmitter 408 that can transfer the oscillation signal onto the laser beam used to create the virtual beacon in order to be embedded in the RF-modulated laser beam. The signals from the mixer circuit 402 can be provided to the low-pass filter 316 in order to provide the phase-conjugated signal Bₙ cos[ωₚ(t+Tₙ)−θ₀] that is to be transmitted from the fiber-optic transmitter 320 back to the array element 106 over the tether 112.

The signal arriving at the fiber-optic receiver 308 may have two primary phase contributions, namely target-to-element accumulated phase and fiber-optic propagation phase. For example, using basic trigonometric identities, the virtual beacon signal may be decomposed into its constituent frequencies, such as in the following manner.

$$S ( t ) = a cos ( {ω}_{c} t ) + \frac{b}{2} cos [ ( {ω}_{c} + {ω}_{p} ) t + {θ}_{0} ] + \frac{b}{2} cos [ ( {ω}_{c} - {ω}_{p} ) t - {θ}_{0} ] .$$

If the distance from the target 104 to the n^{th} array element is denoted Rₙ and the length of the fiber-optic cable connecting the n^{th} array element to its ground-based optical receiver is denoted Lₙ, the optical signal arriving at the receiver 308 of the common ground station 202 may be defined as follows.

$${S}_{R} ( t ) = a cos [ {ω}_{c} ( t - \frac{{R}_{n}}{c} - \frac{{L}_{n}}{v} ) ] + \frac{b}{2} cos [ ( {ω}_{c} + {ω}_{p} ) ( t - \frac{{R}_{n}}{c} - \frac{{L}_{n}}{v} ) + {θ}_{0} ] + \frac{b}{2} cos [ ( {ω}_{c} - {ω}_{p} ) ( t - \frac{{R}_{n}}{c} - \frac{{L}_{n}}{v} ) - {θ}_{0} ] .$$

Here, c represents the speed of light in free space, and v represents the propagation speed in the single-mode optical fiber. This can be expressed in phasor form, such as in the following manner.

$${S}_{R} ( t ) = a exp \{ j [ {ω}_{c} ( t - \frac{{R}_{n}}{c} - \frac{{L}_{n}}{v} ) ] \} + \frac{b}{2} exp \{ j [ ( {ω}_{c} + {ω}_{p} ) ( t - \frac{{R}_{n}}{c} - \frac{{L}_{n}}{v} ) + {θ}_{0} ] \} + \frac{b}{2} exp \{ j [ ( {ω}_{c} - {ω}_{p} ) ( t - \frac{{R}_{n}}{c} - \frac{{L}_{n}}{v} ) - {θ}_{0} ] \} .$$

In some cases, a detector may not respond to signal variations at optical frequencies. A square-law detector may respond to incident power, suitably averaged, such as in the following manner.

$${s}_{R} ( t ) = \frac{1}{2} {S}_{R} ( t ) {S}_{R}^{*} ( t ) = \frac{{a}^{2}}{2} + \frac{{b}^{2}}{4} + ab cos [ {ω}_{p} ( t - T ) + {θ}_{0} ] + \frac{{b}^{2}}{4} cos [ 2 {ω}_{p} ( t + T ) + 2 {θ}_{0} ] ,$$

Here, T=Rₙ/c+Lₙ/v represents a time delay accounting for propagation from the target 104 to the n^{th} array element 106 and from the n^{th} array element 106 along a fiber-optic cable to the central phasing circuitry 314 of the common ground station 202.

The bandpass filter 310 may pass only the frequency components at or near @p, which can be mixed with the oscillation signal at frequency 2ωₚ. Note that the master oscillator 404 can have a common phase that is synchronized across the entire array, which may be expressed as follows.

$${s}_{p} ( t ) = A cos [ {ω}_{p} ( t - T ) + {θ}_{0} ] ,$$

$${s}_{LO} ( t ) = B cos ( 2 {ω}_{p} t ) ,$$

$${s}_{p} ( t ) {s}_{LO} ( t ) = \frac{1}{2} AB cos [ {ω}_{p} ( t + T ) - {θ}_{0} ] + \frac{1}{2} AB cos ( 3 {ω}_{p} t - {ω}_{p} T + {θ}_{0} ) .$$

Here, A and B are signal amplitudes.

The components at or near the frequency Op can represent the phase-conjugated signal. The sign of the total phase ωₚT+θ₀ can be reversed relative to that of sₚ(t). Passing the phase-conjugated signal through a low-pass filter 316 may eliminate the third harmonic, leaving only the phase conjugate of sₚ(t), which may be expressed as follows.

$${s}_{PC} ( t ) = C cos [ {ω}_{p} ( t + T ) - {θ}_{0} ] .$$

Here, C is a signal amplitude.

The phase-conjugated signal s_{PC}(t) can be used to modulate a high-frequency carrier (such as a laser beam) within the fiber-optic transmitter 320, which can be launched onto a fiber-optic cable of the tether 112 for the return trip to the n^{th} array element 106. The resulting signal may be expressed as follows.

$${S}_{RETURN} ( t ) = \{ c + d cos [ {ω}_{p} ( t + T ) - {θ}_{0} ] \} cos ( {ω}_{c}^{′} t ) .$$

Here, c and d are signal amplitudes. Note that the return-trip carrier frequency

$${ω}_{c}^{′}$$

need not be equal to ω_{c}, which may facilitate bidirectional signal propagation on a single fiber-optic cable. In terms of individual frequency components, the following may be expressed.

$${S}_{RETURN} ( t ) = c cos ( {ω}_{c}^{′} t ) + \frac{d}{2} cos [ ( {ω}_{c}^{′} + {ω}_{p} ) t + {ω}_{p} T - {θ}_{0} ] + \frac{d}{2} cos [ ( {ω}_{c}^{′} - {ω}_{p} ) t - {ω}_{p} T + {θ}_{0} ] .$$

The optical signal arriving at the n^{th} array element 106 may be expressed as follows.

$${S}_{RETURN} ( t - \frac{{L}_{n}}{v} ) = c cos [ {ω}_{c}^{′} ( t - \frac{{L}_{n}}{v} ) ] + \frac{d}{2} cos [ ( {ω}_{c}^{′} + {ω}_{p} ) ( t - \frac{{L}_{n}}{v} ) + {ω}_{p} T - {θ}_{0} ] + \frac{d}{2} cos [ ( {ω}_{c}^{′} - {ω}_{p} ) ( t - \frac{{L}_{n}}{v} ) - {ω}_{p} T + {θ}_{0} ] .$$

The output of the optical receiver may be expressed as follows.

$${s}_{RETURN} ( t ) = \frac{{c}^{2}}{2} + \frac{{d}^{2}}{4} + cd cos [ {ω}_{p} ( t + \frac{{R}_{n}}{c} ) - {θ}_{0} ] + \frac{{d}^{2}}{4} cos [ 2 {ω}_{p} ( t + \frac{{R}_{n}}{c} ) - 2 {θ}_{0} ] .$$

The desired frequency component at the pilot signal frequency ωₚ can be isolated, such as by using a suitable filter 324 to eliminate DC components and the RF component at 2ωₚ. The result may be expressed as follows.

$${S}_{TRANSMIT} ( t ) = {C}_{n} cos [ {ω}_{p} ( t + \frac{{R}_{n}}{c} ) - {θ}_{0} ] .$$

This RF signal can be amplified by the amplifier 326 and transmitted towards the virtual beacon 204 using the high-gain antenna 328. The signal arriving at the target 104 may be delayed by Rₙ/c, which could yield the following.

$${S}_{TRANSMIT} ( t - \frac{{R}_{n}}{c} ) = {D}_{n} cos [ {ω}_{p} ( t - \frac{{R}_{n}}{c} + \frac{{R}_{n}}{c} ) - {θ}_{0} ] = {D}_{n} cos [ {ω}_{p} t - {θ}_{0} ] ,$$

where Dₙ is the amplitude of the transmitted signal at the target. The phase of the signal S_{TRANSMIT} here is independent of the index n. Thus, signals from all array elements 106 can arrive at the target 104 with the same or substantially the same phase, which can result in the signals adding coherently.

Although FIG. 4 illustrates one example of a phase conjugation process performed by a common ground station 202, various changes may be made to structure illustrated in FIG. 4.

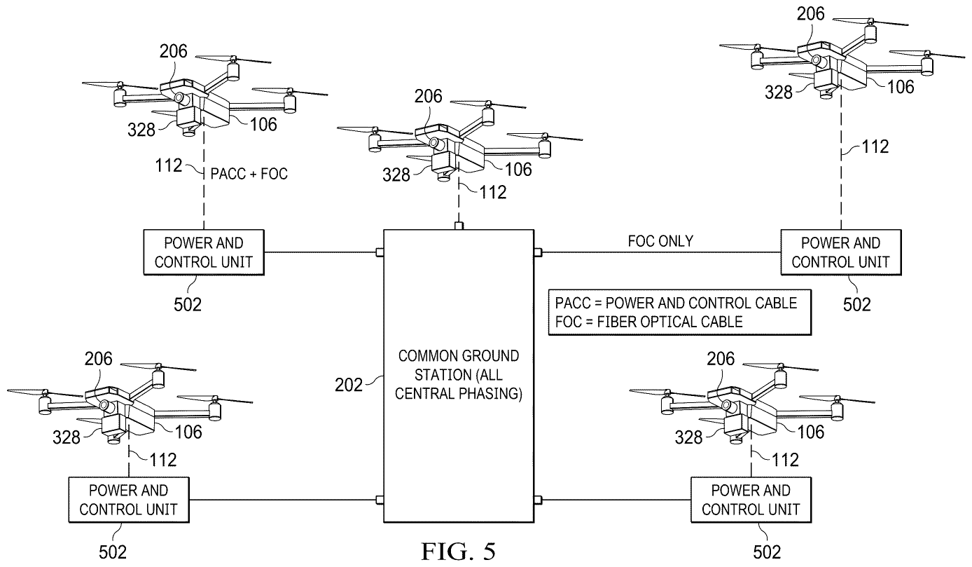

FIG. 5 illustrates example array elements 106 connected to a common ground station 202 over varied tether lengths according to this disclosure. As shown here, the lengths of the tethers 112 between different array elements 106 and the common ground station 202 can vary, and phase conjugated signals can be generated for all of the different tether lengths from the array elements 106. In some cases, the array elements 106 may be directly connected to the common ground station 202. In other cases, the array elements 106 may be connected to the common ground station 202 through power and control units 502. In some cases, the connections to the array elements 106 may include only fiber-optic connections or a combination of power and control cable and fiber-optic connections.

Using the phase-conjugated cancellation techniques disclosed above, the signals transmitted from the array elements 106 toward a target 104 will have the same or substantially the same phase at the target despite the differing lengths of the connections between the common ground station 202 and the array elements 106 and the differences in distances between the array elements 106 and the target 104. This allows the signals transmitted from the array elements 106 to the target 104 to add coherently due to the same or substantially the same phase of the signal.

Although FIG. 5 illustrates one example of array elements 106 connected to a common ground station 202 over varied tether lengths, various changes may be made to structure illustrated in FIG. 5.

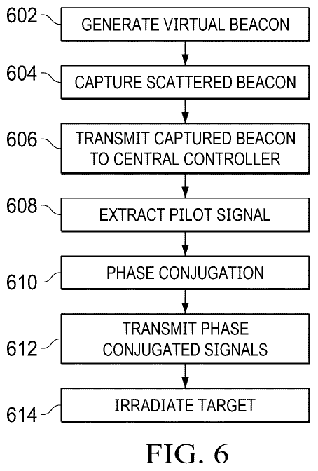

FIG. 6 illustrates an example process 600 for irradiating a target 104 with a distributed retrodirective array 102 according to this disclosure. As shown in FIG. 6, a virtual beacon 204 (including an RF-modulated optical carrier) is generated at step 602 and directed on a target 104. One or more surfaces of the target 104 can scatter the virtual beacon 204 in multiple directions, and the scattered signals can be captured by array elements 106 of a distributed retrodirective array 102 at step 604. The captured scattered signals are transmitted at step 606 to the common ground station 202. A pilot signal is extracted from the RF modulated optical carrier at the common ground station 202 at step 608. This can be done for each array element 106 of the distributed retrodirective array 102.

The extracted RF pilot signals are phase conjugated using the common ground station 202 at step 610. For each array element 106, phase conjugation can reverse the phase of the incident wave. If the received RF pilot signal is of the form cos (ωt−kR), the phase-conjugated signal can be proportional to cos (ωt+kR). The phase-conjugated signals are transmitted from the common ground station 202 back to the array elements 106 at step 612, which allows the array elements 106 to direct the phase-conjugated RF signals onto the target 104 at step 614. This irradiates the target, and the phase-conjugated RF signals from the array elements 106 add coherently at the target 104.

Although FIG. 6 illustrates one example of a process 600 for irradiating a target 104 with a distributed retrodirective array 102, various changes may be made to FIG. 6. For example, while shown as a series of steps, various steps in FIG. 6 may overlap, occur in parallel, occur in a different order, or occur any number of times.

As can be seen from the above description, the distributed retrodirective array 102 of array elements 106 combines the best features of a mobile untethered array and fixed ground-based arrays by providing mobility without the need for onboard power generation or conditioning. Additionally, a distributed mobile system increases survivability and reduces the vulnerability of the array as an adversary target. For instance, the system can continue to operate even if one or more nodes are removed or destroyed. The use of phase conjugation using fiber-optic central phasing compensates for two-way path length variations within the RF path between each array element 106 and the common ground station 202 that may be caused by things such as cable flexing or thermal expansion.

In some embodiments, various functions described in this patent document are implemented or supported by a computer program or other program that is formed from computer readable program code or instructions and that is embodied in a computer or machine readable medium. The phrases “computer readable program code” and “instructions” include any type of code, including source code, object code, and executable code. The phrases “computer readable medium” and “machine readable medium” include any type of medium capable of being accessed by a computer or other machine, such as read only memory (ROM), random access memory (RAM), a hard disk drive (HDD), a compact disc (CD), a digital video disc (DVD), or any other type of memory. A “non-transitory” computer or machine readable medium excludes wired, wireless, optical, or other communication links that transport transitory electrical or other signals. A non-transitory computer or machine readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A system comprising:
an input configured to collect a plurality of RF modulated optical signals scattered from a target;
a common ground station configured to receive and demodulate the collected plurality of RF modulated optical signals scattered from the target and to phase conjugate the received collected plurality of demodulated RF modulated optical signals scattered from the target to generate phase-conjugated RF signals; and
an output configured to provide the phase-conjugated RF signals from the common ground station to each of a plurality of array elements of a distributed retrodirective array; and
wherein phase conjugation of the received plurality of demodulated RF modulated optical signals scattered from the target enable the phase-conjugated RF signals to arrive at the target having substantially a same phase.

2. The system of claim 1, wherein an element-dependent phase of the phase-conjugated RF signals transmitted from the common ground station to the target is cancelled by equal and opposite phase accumulated during propagation from the ground station to the target.

3. The system of claim 1, further comprising:
the plurality of array elements forming the distributed retrodirective array, the array elements configured to collect scattered signals from a virtual beacon on the target and to transmit the phase-conjugated RF signals to the target; and
a plurality of tethered connections configured to connect the array elements to the common ground station and transport the collected plurality of RF modulated optical signals scattered from the target and the phase-conjugated RF signals between the array elements and the common ground station.

4. The system of claim 3, wherein a transmission distance between the target and the common ground station through each of the array elements is different for at least some of the array elements.

5. The system of claim 3, wherein the array elements form a three-dimensional distributed retrodirective array.

6. The system of claim 3, wherein the scattered signals from the virtual beacon contain a radio frequency (RF) pilot signal.

7. The system of claim 1, wherein the common ground station comprises central phasing circuitry configured to generate the phase-conjugated RF signals in response to the collected plurality of RF modulated optical signals scattered from the target.

8. The system of claim 7, wherein the central phasing circuitry comprises:
a master oscillator configured to generate a master oscillation signal;
a plurality of phase conjugation circuits, each phase conjugation circuit associated with one of the array elements and configured to generate the phase-conjugated RF signals responsive to the master oscillator signal and a received RF pilot signal; and
an optical transmitter configured to transmit a virtual beacon signal that creates an RF-modulated virtual beacon on the target in response to the master oscillation signal.

9. A method comprising:
receiving a plurality of RF modulated optical signals scattered from a target from a plurality of array elements of a distributed retrodirective array at a common ground station over a plurality of tethered connections;
demodulating the plurality of RF modulated optical signals scattered from the target at the common ground station;
phase conjugating the received collected plurality of demodulated RF modulated optical signals scattered from the target to generate phase conjugated RF signals at the common ground station; and
transmitting phase-conjugated RF signals from the common ground station to the array elements over the tethered connections.

10. The method of claim 9, wherein an element-dependent phase of the phase-conjugated RF signals transmitted from the common ground station to the target cancels an equal and opposite phase accumulated during propagation from the ground station to the target.

11. The method of claim 9, further comprising:
collecting scattered signals from a virtual beacon on the target using the array elements;
transmitting the collected scattered signals from the array elements to the common ground station over the tethered connections; and
transmitting the phase-conjugated RF signals from the array elements to the target, wherein the phase-conjugated RF signals arrive at the target having substantially a same phase.

12. The method of claim 11, wherein the scattered signals from the virtual beacon
is modulated by a radio frequency (RF) pilot signal.

13. The method of claim 9, further comprising:
forming a three-dimensional distributed retrodirective array with the array elements.

14. The method of claim 9, wherein a transmission distance between the target and the common ground station through each of the array elements is different for at least some of the array elements.

15. The method of claim 9, wherein phase conjugation comprises generating the phase-conjugated RF signals in response to the received plurality of RF modulated optical signals scattered from the target using central phasing circuitry.

16. The method of claim 15, wherein the central phasing circuitry comprises:
a master oscillator configured to generate a master oscillation signal;
a plurality of phase conjugation circuits, each phase conjugation circuit associated with one of the array elements and configured to generate the phase-conjugated RF signals responsive to the master oscillator signal and a received RF pilot signal; and
an optical transmitter configured to transmit a virtual beacon signal that creates an RF-modulated virtual beacon on the target in response to the master oscillation signal.

17. A distributed retrodirective array system comprising:
a plurality of array elements configured to form a three-dimensional distributed retrodirective array, the array elements configured to collect a plurality of scattered RF-modulated optical signals from a virtual beacon modulated by a radio frequency (RF) pilot signal on a target and transmit phase-conjugated signals to the target;
a common ground station configured to receive and demodulate the collected plurality of scattered RF modulated optical signals from the target and to phase conjugate the received collected plurality of demodulated scattered RF modulated optical signals to generate phase-conjugated RF signals;
a plurality of tethered connections configured to connect the array elements to the common ground station and transport the collected plurality of scattered RF-modulated optical signals and the phase-conjugated RF signals between the array elements and the common ground station; and
wherein conjugated phases of the collected plurality of demodulated scattered RF-modulated optical signals enable the phase-conjugated RF signals to arrive at the target having substantially a same phase.

18. The system of claim 17, wherein the phase-conjugated RF signals add coherently at the target in response to the substantially same phase of the phase-conjugated RF signals.

19. The system of claim 17, wherein a transmission distance between the target and the common ground station through each of the array elements is different for at least some of the array elements.

20. The system of claim 17, wherein the common ground station further comprises central phasing circuitry comprising:
a master oscillator configured to generate a master oscillation signal;
a plurality of phase conjugation circuits, each phase conjugation circuit associated with one of the array elements and configured to generate the phase-conjugated RF signals responsive to the master oscillator signal and a received RF pilot signal; and
an optical transmitter configured to transmit a virtual beacon signal that creates an RF-modulated virtual beacon on the target in response to the master oscillation signal.
